(19) United States
(12) Patent Application Publication
(10) Pub. No.: US 2021/0280841 A1
(43) Pub. Date: Sep. 9, 2021

(54) BUNDLING METHOD, MANUFACTURING METHOD OF BATTERY, AND BUNDLING APPARATUS

(71) Applicant: KABUSHIKI KAISHA TOSHIBA, Tokyo (JP)

(72) Inventors: Takahiro AIZAWA, Yokohama (JP); Kazuo SHIMOKAWA, Yokohama (JP); Takashi ITO, Yokohama (JP); Masatoshi TANABE, Yokohama (JP)

(73) Assignee: KABUSHIKI KAISHA TOSHIBA, Tokyo (JP)

(21) Appl. No.: 17/094,917

(22) Filed: Nov. 11, 2020

(30) Foreign Application Priority Data
Mar. 3, 2020 (JP) 2020-035795

(51) Int. Cl. H01M 4/04; B65B 13/04; B65B 13/24

(52) U.S. Cl. CPC H01M 4/043; H01M 2004/028; B65B 13/24; B65B 13/04

(57) ABSTRACT

According to an embodiment, a bundling method and a bundling apparatus of a plurality of band-shaped parts of a current collecting tab in an electrode group, in which the current collecting tab projects, are provided. In the bundling method and apparatus, the current collecting tab is deformed by moving a bundling tool, with the bundling tool being abutted to the current collecting tab from an outer side in a lamination direction of a plurality of band-shaped parts. At this time, the bundling tool is moved so that a moving direction of the bundling tool is inclined with respect to the lamination direction of the plurality of band-shaped parts, toward a side opposite to a side where the current collecting tab projects.

### CROSS-REFERENCE TO RELATED APPLICATIONS

This application is based upon and claims the benefit of priority from Japanese Patent Application No. 2020-035795, filed Mar. 3, 2020, the entire contents of which are incorporated herein by reference.

### FIELD

Embodiments described herein relate generally to a bundling method, a manufacturing method of a battery, and a bundling apparatus.

### BACKGROUND

A battery, such as a secondary battery, includes an electrode group, and the electrode group includes a positive electrode and a negative electrode. In the electrode group, current collecting tab projects. In the battery, the current collecting tab is electrically connected to an electrode terminal via one or more leads, etc. In the current collecting tab, a plurality of band-shaped parts are laminated.

In manufacturing of the above-describe battery, the current collecting tab is connected (joined) to a lead, etc. so as to be electrically connected to the electrode terminal, with the plurality of band-shaped parts bundled in the current collecting tab. The plurality of band-shaped parts are bundled by deforming the current collecting tab using a bundling tool. The task of bundling the plurality of band-shaped parts of the current collecting tab as described above requires reduction of the influence of tension caused by the deformation of the current collecting tab, adequate deformation of the current collecting tab, and adequate bundling of the plurality of band-shaped parts.

### BRIEF DESCRIPTION OF THE DRAWINGS

FIG. 1 is a block diagram schematically showing an example of a bundling apparatus according to a first embodiment.

FIG. 2 is a schematic diagram of an example of a battery manufactured with the use of the bundling apparatus according to the first embodiment.

FIG. 3 is a schematic diagram showing a state prior to bundling of a plurality of band-shaped parts in a task of bundling the plurality of band-shaped parts of a current collecting tab performed by the bundling apparatus according to the first embodiment.

FIG. 4 is a schematic diagram of a bundled state of the plurality of band-shaped parts in the task of bundling the plurality of band-shaped parts of the current collecting tab performed by the bundling apparatus according to the first embodiment.

FIG. 5 is a schematic diagram explaining a moving of a bundling tool in the task of bundling the plurality of band-shaped parts of the current collecting tab performed by the bundling apparatus according to the first embodiment.

FIG. 6 is a schematic diagram of a moving of the bundling tool in the task of bundling the plurality of band-shaped parts of the current collecting tab performed by the bundling apparatus according to a modification.

### DETAILED DESCRIPTION

According to an embodiment, a bundling method of a plurality of band-shaped parts of a current collecting tab in an electrode group in which the current collecting tab projects is provided. In the bundling method, the current collecting tab is deformed by moving a bundling tool, with the bundling tool being abutted to the current collecting tab from an outer side in a lamination direction of a plurality of band-shaped parts. At this time, the bundling tool is moved in such a manner that a moving direction of the bundling tool is inclined with respect to the lamination direction of the plurality of band-shaped parts, toward a side opposite to a side where the current collecting tab projects.

An embodiment provides a manufacturing method of a battery using the above-described bundling method. In the manufacturing method, a positive electrode and a negative electrode constitute an electrode group in such a manner the current collecting tab projects. Furthermore, in the manufacturing method, a plurality of band-shaped parts are bundled in the current collecting tab of the electrode group by the above-described bundling method. Then, in the manufacturing method, the current collecting tab in which the plurality of band-shaped parts are bundled is electrically connected to an electrode terminal.

According to an embodiment, a bundling apparatus configured to bundle a plurality of band-shaped parts of a current collecting tab in an electrode group in which the current collecting tab projects is provided. The bundling apparatus includes a bundling tool and a controller. The bundling tool is abuttable to the current collecting tab from an outer side in a lamination direction of the plurality of band-shaped parts. The controller moves the bundling tool, with the bundling tool being abutted to the current collecting tab, and the current collecting tab is thereby deformed. At this time, the controller controls the moving of the bundling tool in such a manner that a moving direction of the bundling tool is inclined with respect to the lamination direction of the plurality of band-shaped parts, toward a side opposite to a side where the current collecting tab projects.

Descriptions will now be given of the embodiments with reference to the accompanying drawings.

### FIRST EMBODIMENT

FIG. 1 shows an example of a bundling apparatus 1 according to the first embodiment. The bundling apparatus 1 is used to manufacture batteries, such as secondary batteries. Thus, the bundling apparatus 1 constitutes a part of a battery manufacturing apparatus. The bundling apparatus 1 is used in a task of bundling a plurality of band-shaped parts of a current collecting tab (described later) in an electrode group of a battery. The bundling apparatus 1 includes a bundling tool 2, a driving source 3, and a controller 5. The driving source 3 is a motor, etc. driven by electric power, etc. The bundling tool 2 is moved by driving the driving source 3.

The controller 5 is a computer, for example. The controller 5 includes a processor or an integrated circuit (control circuit) including a CPU (central processing unit), an ASIC (application specific integrated circuit), or an FPGA (field programmable gate array), and a storage medium, such as a memory. The controller 5 may include only one integrated circuit, etc., or a plurality of integrated circuits, etc. The controller 5 performs processing by executing a program, etc. stored in the storage medium, etc. The controller 5 controls the moving of the bundling tool 2 by controlling the driving of the driving source 3.

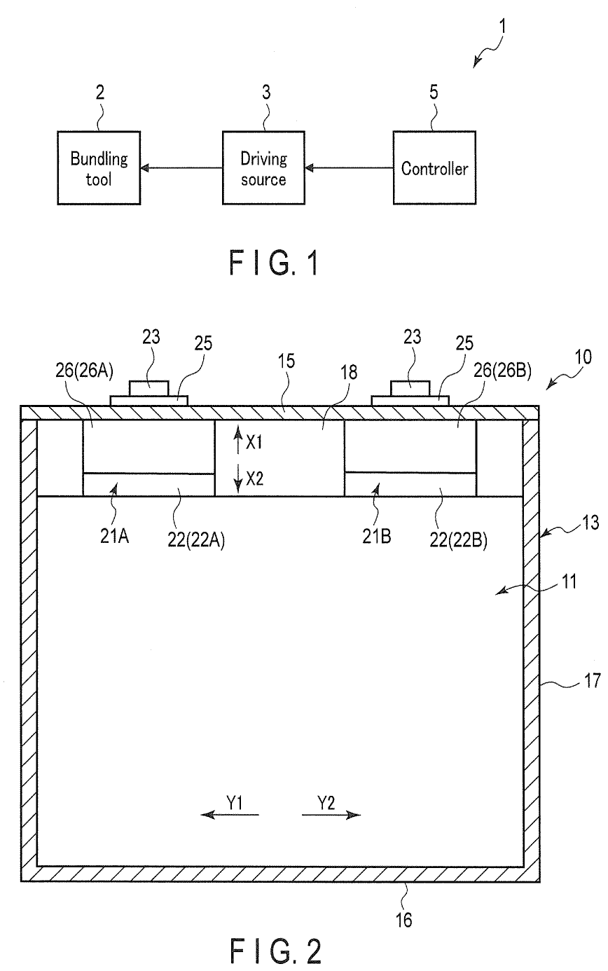

FIG. 2 shows an example of a battery 10 manufactured with the use of the bundling apparatus 1. In the example shown in FIG. 2, the battery 10 includes an electrode group 11, an exterior container 13, and a lid member 15. The exterior container 13 and the lid member 15 are made of metal. The exterior container 13 includes a bottom wall and a peripheral wall 17, and these walls define an inner hollow 18 where the electrode group 11 is stored. In the exterior container 13, the inner hollow 18 opens to the side opposite to the side where the bottom wall 16 is located. The lid member 15 is attached to the peripheral wall 17 at the end opposite to the bottom wall 16, and covers the opening of the inner hollow 18 of the exterior container 13.

The electrode group 11 includes a positive electrode 21A and a negative electrode 21B. In the electrode group 11, there is a separator (not shown) interposed between the positive electrode 21A and the negative electrode 21B. The separator is made of a material having electric insulating properties, and electrically insulates the positive electrode 21A from the negative electrode 21B.

The positive electrode 21A includes a positive electrode current collector, such as a positive electrode current collecting foil, and a positive electrode active material-containing layer (not shown) supported on the surface of the positive electrode current collector. The positive electrode current collector is for example, although not limited thereto, an aluminum foil or aluminum alloy foil having a thickness of about 10 μm to 20 μm. The positive electrode active material containing layer includes a positive electrode active material, and may include a binder and a conductive agent as appropriate. The positive electrode active material is for example, although not limited thereto, an oxide, a sulfide, or a polymer that can occlude and release lithium ions. The positive electrode current collector includes a positive electrode current collecting tab 22A as a portion where no positive electrode active material containing layer is supported.

The negative electrode 21B includes a negative electrode current collector, such as a negative electrode current collecting foil, and a negative electrode active material-containing layer (not shown) supported on the surface of the negative electrode current collector. The negative electrode current collector is for example, although not limited thereto, an aluminum foil, aluminum alloy foil, or a copper foil having a thickness of about 10 μm to 20 μm. The negative electrode active material containing layer includes a negative electrode active material, and may include a binder and a conductive agent as appropriate. The negative electrode active material is for example, although not limited thereto, a metal oxide, a metal sulfide, a metal nitride, or a carbon material that can occlude and release lithium ions. The negative electrode current collector includes a negative electrode current collecting tab 22B as a portion where no negative electrode active material containing layer is supported.

As described above, the electrode group 11 includes a positive electrode current collecting tab 22A as one of the pair of the current collecting tabs 22, and a negative electrode current collecting tab 22B as the other of the pair of the current collecting tabs 22, which differs from the positive electrode current collecting tab 22A. In the electrode group 11 of an example, the positive electrode 21A, the negative electrode 21B, and the separator are wound around the winding axis, with the separator being interposed between the positive electrode active material containing layer and the negative electrode active material containing layer. In another example, the electrode group 11 has a stack structure where a plurality of positive electrodes 21A and a plurality of negative electrodes 21B are alternately laminated, with the separator interposed therebetween. In the electrode group 11 in the example shown in FIG. 2, the positive electrode current collecting tab 22A projects with respect to the negative electrode 21B and the separator. The negative electrode current collecting tab 22B thus projects on a side where the positive electrode current collecting tab 22A projects, with respect to the positive electrode 21A and the separator. In other words, in the electrode group 11, the pair of the current collecting tabs 22 projects on the same side with respect to each other.

In the electrode group 11, the projection direction of the current collecting tabs 22 (the direction indicated by arrow X1), and the direction opposite to the projection direction of the current collecting tabs 22 (the direction indicated by arrow X2) are defined. Furthermore, in the electrode group 11, the width direction (the direction indicated by arrows Y1 and Y2) intersecting with (perpendicular or approximately perpendicular to) the projection direction of the current collecting tabs 22, and the thickness direction (the perpendicular direction of the sheet of FIG. 2) intersecting with both of the projection direction of the current collecting tabs 22 and the width direction are defined. Then, in the electrode group 11, the dimension in the thickness direction is smaller than each of the dimension in the projection direction of the current collecting tabs 22 and the dimension in the width direction. For this reason, the electrode group 11 is formed in a flat shape. In the example shown in FIG. 2, the current collecting tabs 22 as a pair are separately arranged from each other in the width direction of the electrode group 11. Furthermore, in the inner hollow 18 of the exterior container 13, the current collecting tabs 22 project toward the side where the lid member 15 is located.

In the inner hollow 18, the electrode group 11 is impregnated with an electrolytic solution (not shown) (in other words, an electrolytic solution is supported in the electrode group 11). The electrolytic solution may be a nonaqueous electrolyte solution obtained by dissolving an electrolyte into an organic solvent, or an aqueous electrolyte solution such as a water solution. Instead of an electrolyte solution, a gel-type electrolyte or a solid electrolyte may be used. If a solid electrolyte is used as an electrolyte, in the electrode group, the solid electrode group is interposed between the positive electrode 21A and the negative electrode 21B, in place of the separator. In this case, the solid electrolyte electrically insulates the positive electrode 21A from the negative electrode 21B.

In the battery 10 of the example shown in FIG. 2, a pair of electrode terminals 23 is attached on the outer surface of the lid member 15. One of the electrode terminals 23 serves as a positive electrode terminal of the battery 10, and the other serves as the negative electrode terminal of the battery 10. For this reason, the electrode terminals 23 have opposite polarities. An insulating member 25 is interposed between each of the electrode terminals 23 and the outer surface of the lid member 15. Each of the electrode terminals 23 is electrically insulated from the lid member 15 and the exterior container 13 by the insulating member 25.

Each of the current collecting tabs 22 is electrically connected to a corresponding one of the electrode terminals 23, with one or more of the leads 26 being interposed therebetween. For example, the positive electrode current collecting tab 22A is electrically connected to the positive electrode terminal, with one or more positive electrode leads including a positive electrode lead 26A, which is one of the leads 26, interposed therebetween. Then, the negative electrode current collecting tab 22B is electrically connected to the negative electrode terminal, with one or more negative electrode leads including a negative electrode lead 26B, which is one of the leads 26, interposed therebetween. In the inner hollow 18, each of the current collecting tabs 22 and the leads 26 is electrically insulated from the exterior container 13 and the lid member 15 by one or more insulating members (not shown).

In the manufacturing of the battery 10 as in the example shown in FIG. 2, the positive electrode 21A and the negative electrode 21B constitute the electrode group 11. At this time, the electrode group 11 is formed in such a manner that each current collecting tab 22 projects. Then, each current collecting tab 22 is electrically connected to a corresponding one of the electrode terminals 23, with one or more of the leads 26 being interposed therebetween. At this time, in an example, the positive electrode-side lead 26A is connected to the positive electrode current collecting tab 22A by ultrasonic welding, etc., and the negative electrode-side lead 26B is connected to the negative electrode current collecting tab 22B by ultrasonic welding, etc. The positive electrode-side lead 26A may be directly connected (joined) to the positive electrode current collecting tab 22A, and may be connected to the positive current collecting tab 22A with a clip called a “backup lead” being interposed therebetween as a gripping member that grips the current collecting tab. Similarly, the negative electrode-side lead 26B may be directly connected (joined) to the negative electrode current collecting tab 22B, and may be connected to the negative electrode current collecting tab 22B with the clip being interposed therebetween.

In each current collecting tab 22, a plurality of band-shaped parts are laminated. In the manufacturing of the battery 10, before electrically connecting each current collecting tab 22 to a corresponding one of the electrode terminals 23, the plurality of band-shaped parts are bundled in each collecting tab 22. Thus, each current collecting tab 22 is electrically connected to a corresponding one of the electrode terminals 23 with the plurality of band-shaped parts being bundled and one or more of the leads 26 being interposed therebetween. The bundling apparatus 1 that includes the bundling tool 2 is used in a task of bundling the plurality of band-shaped parts in each current collecting tab 22.

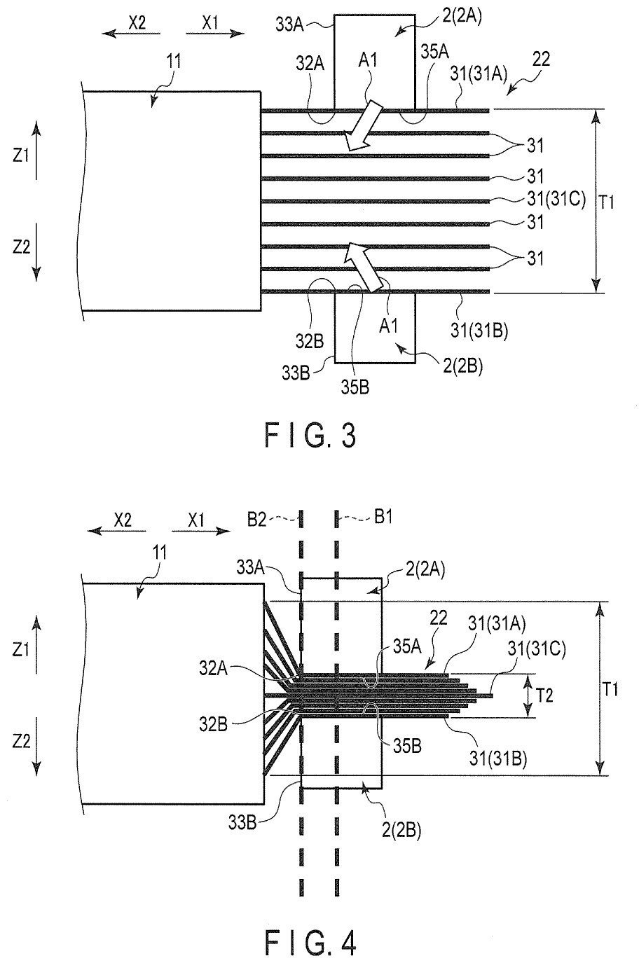

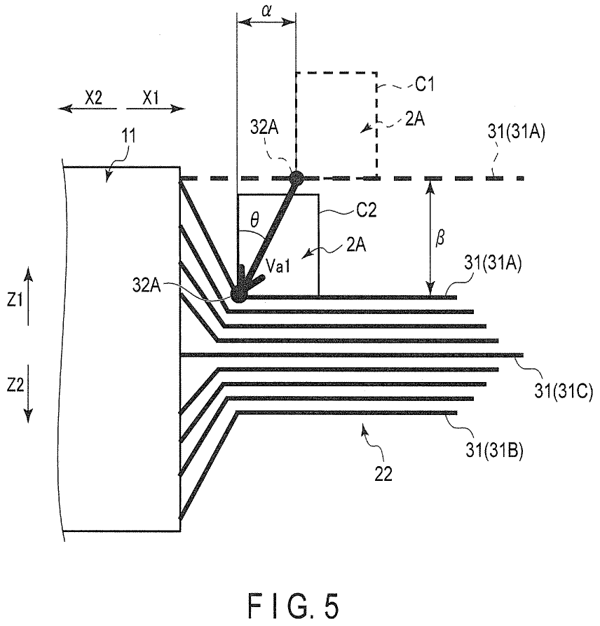

FIGS. 3 to 5 explain the task of bundling the plurality of band-shaped parts 31 of the current collecting tab 22 performed by the bundling apparatus 1. FIG. 3 shows a state before the plurality of band-shaped parts 31 are bundled, and. FIGS. 4 and 5 show a bundled state of the plurality of band-shaped parts 31. As shown in FIGS. 3 to 5, the lamination direction of the plurality of band-shaped parts 31 in the current collecting tab 22 corresponds to or approximately corresponds to the thickness direction of the electrode group 11 (the direction indicated by arrow Z1 and arrow Z2 in FIGS. 3 to 5, etc.). Thus, the lamination direction of the plurality of band-shaped parts 31 intersects (is perpendicular or approximately perpendicular to) both of the projection direction of the current collecting tab 22 and the width direction of the electrode group 11.

As shown in FIG. 3, in the state before being bundled, each of the band-shaped parts 31 extends straight or approximately straight along the projection direction of the current collecting tab 22 from the bottom of the projection of the current collecting tab 22 to the projection end. When the band-shaped parts 31 are bundled together, the bundling tool 2 is made to abut to the current collecting tab 22 from an outer side in the lamination direction of the band-shaped parts 31. In the example shown in FIGS. 3 through 5, the bundling tool 2A is made to abut to the outermost band-shaped part 31A from one side of the lamination direction of the band-shaped parts 31. Then, the bundling tool 2B is made to abut to the outermost band-shaped part 31B opposite to the band-shaped part 31A, from the side opposite to the bundling tool 2A in the lamination direction of the band-shaped parts 31.

Then, with each of the bundling tools 2 (2A, 2B) being abutted to the current collecting tab 22, each of the bundling tools 2 is moved (arrow A1 of FIG. 3). At this time, the controller 5 moves each bundling tool 2 by driving the driving source 3. The moving direction of each bundling tool 2 is inclined toward the side (the arrow X2 side) opposite to the side, toward which the current collecting tab 22 projects, with respect to the lamination direction of the band-shaped parts 31. Thus, in the task of bundling the band-shaped parts 31, each bundling tool 2 moves toward the inside of the lamination direction of the band-shaped parts 31 and moves toward the side opposite to the side on which the current collecting tab 22 projects, at the same time. As a result of the moving of each bundling tool 2 in the above-described manner, the current collecting tab 22 is pressed from each bundling tool 2 toward the moving direction. The current collecting tab 22 is thus deformed.

As shown in FIG. 4, in the task of bundling the band-shaped parts 31, each of the edge 32A of the bundling tool 2A and the edge 32B of the bundling tool 2B moves, from the position B1 to the position B2, in the direction opposite to the projection direction of the current collecting tab 22, in other words, to the side where the bottom of the projection of the current collecting tab 22 is located. The bundling tool 2A has a surface 33A facing the side opposite to the side where the current collecting tab 22 projects, and a surface 35A facing the inside of the lamination direction of the band-shaped parts 31. In the task of bundling the band-shaped parts 31, the surface 35A is made to abut to the band-shaped parts 31A. Then, in the bundling tool 2A, the corner between the surfaces 33A and 35A is constituted by the edge 32A. As to the bundling tool 2B, similarly to the bundling tool 2A, the surfaces 33B and 35B are provided, and the corner between the surfaces 33B and 35B is constituted by the edge 32B. In the task of bundling the band-shaped parts 31, the surface 35B is made to abut to the band-shaped parts 31B.

As a result of the deformation of the current collecting tab 22 caused by the above-described moving of the bundling tool 2, the plurality of band-shaped parts 31 are bundled between the position B2 and the projection end of the current collecting tab 22. For this reason, between the position B2 and the projection end in the current collecting tab 22, the dimension of the current collecting tab 22 in the lamination direction of the band-shaped parts 31 is reduced compared to the dimension before the task of bundling the band-shaped parts 31 is performed. For example, as a result of the task of bundling the band-shaped parts 31, between the position B2 and the projection end, the dimension (thickness) of the current collecting tab 22 in the lamination direction of the band-shaped parts 31 decreases from a value T1 to a value T2. At the bottom of the projection of the current collecting tab 22, even after the bundling task is performed, he dimension of the current collecting tab 22 in the lamination direction of the band-shaped parts 31 does not or almost does not change from the value T1, which is the dimension before the bundling task is performed.

As a result of the deformation of the current collecting tab 22 caused by the above-described moving of the bundling tool 2, at the location between the bottom of the projection of the current collecting tab 22 and the position B2, the dimension of the current collecting tab 22 in the lamination direction of the band-shaped parts 31 becomes smaller at the site closer to the position B2. In the example shown in FIGS. 3 to 5, the dimension of the current collecting tab 22 in the lamination direction of the band-shaped parts 31 decreases from the value T1 to the value T2, in the location between the bottom of the projection of the current collecting tab 22 and the position B2. Then, in the current collecting tab 22 for which the bundling task has been performed, in the range between the bottom of the projection of the current collecting tab 22 and the position B2, each of the band-shaped parts 31, except for the band-shaped parts located in the center of the lamination (e.g., the band-shaped parts 31C), extends in such a manner that the band-shaped part is inclined relative to the projection direction of the current collecting tab 22. Thus, in the range between the bottom of the projection of the current collecting tab 22 and the position B2, each of the band-shaped parts 31, except for the band-shaped parts located in the center of the lamination, is inclined in such a manner that the band-shape part is located closer to the inside of the lamination direction as the band-shaped part is closer to the position B2.

FIG. 5 shows the moving of the bundling tool 2A during a task of bundling the plurality of band-shaped parts 31. In the task of bundling, the bundling tool 2A is moved from the position C1 to the position C2. In FIG. 5, the motion vector Va1 of the edge 32A of the bundling tool 2A during the bundling task is indicated. The vector direction of the motion vector Va1 corresponds to the moving direction of the bundling tool 2A from the position C1 to the position C2.

Herein, the angle of inclination θ, which is an acute angle formed by the moving direction of the bundling tool 2A with respect to the lamination direction of the plurality of band-shaped parts 31, is defined. In the deformation of the current collecting tab 22 caused by the moving of the bundling tool 2A, a displacement α of the outermost band-shaped part 31A toward the side opposite to the side where the current collecting tab 22 projects, and the displacement β of the band-shaped part 31A toward the inside of the lamination direction are defined. The displacement α corresponds to an amount of movement of the bundling tool 2A toward the side opposite to the side where the current collecting tab 22 projects, and the displacement β corresponds to an amount of movement of the bundling tool 2A toward the inside of the lamination direction. In the moving of the bundling tool 2A of which the moving direction is inclined with respect to the lamination direction of the band-shaped parts 31, the bundling tool 2A is moved so as to satisfy the following expression (1). Thus, the controller 5 controls driving of the driving source 3 and moving of the bundling tool 2A so as to satisfy the expression (1).

tan θ=α/β (1)

As for the moving of the bundling tool 2B of which the moving direction is inclined with respect to the lamination direction of the band-shaped parts 31, the bundling tool 2B is also moved so as to satisfy the expression similar to the expression (1). Thus, the controller 5 controls driving of the driving source 3 and moving of the bundling tool 2B so as to satisfy the expression similar to the expression (1).

As described above, in the present embodiment, in the task of bundling the plurality of band-shaped parts 31, the current collecting tab 22 is deformed by moving each of the bundling tools 2, with each of the bundling tools 2 abutted to the current collecting tab 22 from the outer side of the lamination direction of the band-shaped parts 31. At this time, the moving direction of each of the bundling tools 2 is inclined with respect to the lamination direction of the plurality of band-shaped parts 31, toward the side opposite to the side where the current collecting tab 22 projects. By moving each of the bundling tools 2 toward the inside of the lamination direction of the band-shape parts 31 and at the same time toward the side opposite to the side where the current collecting tab projects, it is possible to effectively prevent slipping of the outermost band-shaped parts 31A and 31B with respect to the bundling tool 2 to which the outermost band-shaped parts 31A and 31B are respectively abutted. It is thereby possible to reduce friction between each of the bundling tools 2 and the current collecting tab 22 in the task of bundling the band-shaped parts 31.

In the task of bundling the band-shaped parts 31, as a result of the deformation of the current collecting tab 22, tension is caused in each of, the band-shaped parts 31 at a site closer to the bottom of the projection of the current collecting tab 22 than to the bundling tool 2. In the example shown in FIGS. 3 to 5, etc., the further the band-shaped part 31 is located from the center of the lamination, the greater the tension becomes. In the present embodiment, as described above, each of the bundling tools 2 is moved toward the inside of the lamination direction of the band-shaped parts 31, and at the same time toward the side opposite to the side where the current collecting tab 22 projects. For this reason, the tension caused in the current collecting tab 22 is more reduced compared to the case where, for example, the bundling tool is moved only toward the inside of the lamination direction of the band-shaped parts 31. Accordingly, even in the band-shaped parts arranged far from the center portion in the lamination direction, such as the outermost band-shaped parts 31A and 31B, the tension caused by the deformation of the current collecting tab 22 does not increase. Thus, in the task of bundling the plurality of band-shaped parts 31 of the current collecting tab 22, the influence of the tension caused by the deformation of the current collecting tab 22 is reduced.

In the bundling of the band-shaped parts 31 using the bundling apparatus 1 of the present embodiment as described above, the friction between each of the bundling tools 2 and the current collecting tab 22 is reduced, and the influence of the tension caused by the deformation of the current collecting tab 22 is reduced. For this reason, the plurality of the band-shaped parts 31 are appropriately bundled. Furthermore, damage to the current collecting tab 22 due to either the above-described friction or tension can be effectively prevented, and the band-shaped parts 31 are bundled with high accuracy. Thus, yield becomes higher in the manufacturing of the battery 10.

### MODIFICATION

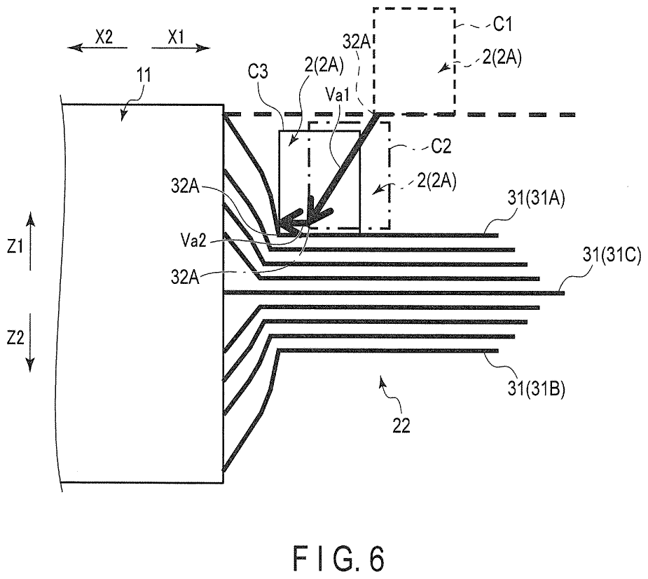

Also, in the modification shown in FIG. 6, similarly to the foregoing embodiment, etc., each of the bundling tools 2 (2A, 2B) is moved in such a manner that the moving direction is inclined with respect to the lamination direction of the plurality of band-shaped parts 31, and the current collecting tab 22 is deformed. For this reason, also in the present modification, the bundling tool 2A moves from the position C1 to the position C2, and the edge 32A of the bundling tool 2A is moved as indicated by the motion vector Va1. In the present modification, however, after moving each of the bundling tools 2 as described above, each of the bundling tools 2 is further moved to the side opposite to the side where the current collecting tab 22 projects, with the bundling tool 2 being abutted to the current collecting tab 22. As a result, the current collecting tab 22 is pressed by the bundling tool toward the side where the bottom of the projection of the current collecting tab 22 is located, and the current collecting tab 22 is further deformed.

In the present modification, after each of the bundling tools 2 is moved in a manner similar to the foregoing embodiment, etc., each of the bundling tools 2 is further moved to the side opposite to the side where the current collecting tab 22 projects. For this reason, in the present modification, because of the pressing by the bundling tool 2 to the side opposite to the side where the current collecting tab 22 projects, the band-shaped parts arranged far from the center portion in the lamination direction, such as the outermost band-shaped parts 31A and 31B, are warped, from the deformed state similar to that in the foregoing embodiment, etc. Thus, the tension is further reduced in the band-shaped parts arranged far from the center portion in the lamination direction, which leads to a further reduction of tension caused in the current collecting tab 22.

In the foregoing embodiment, the bundling tools 2 are made to abut to the current collecting tab 22 from both sides of the lamination direction of the band-shaped parts 31, and both of the bundling tools 2 abutted to the current collecting tab 22 are moved as described above; however, the embodiment is not limited to this example. In one modification, only one of the bundling tools 2 abutted to the current collecting tab 22 (for example, the bundling tool 2A) is moved as described above, and the other of the bundling tools 2 (for example, the bundling tool 2B) may not have to be moved. Also in the present modification, similarly to the foregoing embodiment, etc., friction between the bundling tool (2A, for example) to be moved and the current collecting tab 22 is reduced, and an influence of tension caused by the deformation of the current collecting tab 22 is reduced. For this reason, the operations and advantageous effects similar to those of the foregoing embodiment, etc. are achieved in the present modification.

In the foregoing embodiment, etc., in the electrode group 11 of the battery 10 manufactured using the bundling apparatus 1, a positive electrode current collecting tab 22A and a negative electrode current collecting tab 22B project on the same side with respect to each other, but the bundling apparatus 1 can also be used for manufacturing a battery having a configuration differing from that of the battery 10. For example, the bundling apparatus 1 can also be used for manufacturing a battery having a configuration in which a positive electrode current collecting tab and a negative electrode current collecting tab project the opposite side with respect to each other, as disclosed in reference document 1 (Jpn. Pat. Appln. KOKAI Publication No. 2011-71109) and reference document 2 (International Publication No. 2016/204147). In this case, similarly to one of the foregoing embodiments, etc., in each of the current collecting tabs 22, the plurality of band-shaped parts 31 are bundled by the bundling apparatus 1 including the bundling tool 2.

Furthermore, the exterior part of the battery 10 manufactured with the use of the bundling apparatus 1 is not limited to a structure constituted by the exterior container 13 and the lid member 15. In one modification, as described in the reference document 2, an exterior part may be constituted by a first exterior member and a second exterior member, which are made of a metal. In this case, the first exterior member includes a bottom wall and a peripheral wall, and in the first exterior member, a flange projects toward the outer peripheral side in the peripheral wall, from the edge on the opposite side of the bottom wall. Then, a second exterior member is attached to a flange of the first exterior member. In another modification, an exterior part of a battery may be made of a laminated film having a three-layer structure in which a metal layer is interposed between resin layers. In any modification, similarly to one of the foregoing embodiments, etc., a plurality of band-shaped parts 31 are bundled in each current collecting tab 22 by the bundling apparatus 1 including a bundling tool 2.

In at least one of the foregoing embodiments, etc., a bundling tool is moved, with the bundling tool abutted to a current collecting tab from an outer side in the lamination direction of a plurality of band-shaped parts. At this time, the bundling tool is moved in such a manner that the moving direction of the bundling tool is inclined with respect to the lamination direction of a plurality of band-shaped parts, toward the side opposite to the side where the current collecting tab projects. It is thereby possible to provide a bundling method and a bundling apparatus that reduces an influence of tension and to achieve an appropriate bundling of a plurality of band-shaped parts in a task of bundling the band-shaped parts of a current collecting tab.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A bundling method of a plurality of band-shaped parts of a current collecting tab in an electrode group where the current collecting tab projects, the method comprising:
deforming the current collecting tab by moving a bundling tool, with the bundling tool being abutted to the current collecting tab from an outer side in a lamination direction of the plurality of band-shaped parts, wherein the bundling tool is moved in such a manner that a moving direction of the bundling tool is inclined with respect to the lamination direction of the plurality of band-shaped parts toward a side opposite to a side where the current collecting tab projects.

2. The bundling method according to claim 1, wherein
in a moving of the bundling tool in which the moving direction is inclined with respect to the lamination direction of the plurality of band-shaped parts, the following expression (A) is satisfied:
tan θ=α/β (A),
wherein θ represents an angle of inclination which is an acute angle made by the moving direction of the bundling tool with respect to the lamination direction of the plurality of band-shaped parts, α represents a displacement of an outermost band-shaped part to a side opposite to the side where the current collecting tab projects, the displacement occurring in deformation of the current collecting tab caused by the moving of the bundling tool, and β represents a displacement of the outermost band-shaped part to an inside of the lamination direction, the displacement occurring in the deformation of the current collecting tab caused by the moving of the bundling tool.

3. The bundling method according to claim 1, further comprising:
deforming the current collecting tab by moving the bundling tool further, with the bundling tool being abutted to the current collecting tab, toward a side opposite to the side where the current collecting tab projects, after deforming the current collecting tab by moving the bundling tool in the moving direction inclined with respect to the lamination direction of the plurality of band-shaped parts.

4. A manufacturing method of battery, comprising:
forming an electrode group from a positive electrode and a negative electrode in such a manner that the current collecting tab projects;
bundling the plurality of band-shaped parts in the current collecting tab of the electrode group by the bundling method according to claim 1; and
electrically connecting the current collecting tab in which the plurality of band-shaped parts are bundled to an electrode terminal.

5. A bundling apparatus configured to bundle a plurality of band-shaped parts of a current collecting tab in an electrode group in which the current collecting tab projects, the apparatus comprising:
a bundling tool abuttable to the current collecting tab from an outer side in a lamination direction of the plurality of band-shaped parts; and
a controller configured to move the bundling tool with the bundling tool being abutted to the current collecting tab and thereby configured to deform the current collecting tab, the controller being configured to control a moving of the bundling tool in such a manner that a moving direction of the bundling tool is inclined with respect to the lamination direction of the plurality of band-shaped parts, toward a side opposite to a side where the current collecting tab projects.
